(19) United States
(12) Patent Application Publication
(10) Pub. No.: US 2026/0122168 A1
(43) Pub. Date: Apr. 30, 2026

(54) INTELLIGENT SYNCHRONOUS DATA TRANSMISSION SCHEDULING FOR CO-EXISTENCE

(71) Applicant: Silicon Laboratories Inc., Austin, TX (US)

(72) Inventors: Jitesh Rachamadugu, Hyderabad (IN); Sandeep Voruganti, Hyderabad (IN); Ayan B. Ghosh, Hyderabad (IN); Moin Khan, Hyderabad (IN); Niranjan Kumar Jonnada, Hyderabad (IN); Suresh Babu Sykam, Hyderabad (IN)

(21) Appl. No.: 18/925,951

(22) Filed: Oct. 24, 2024

(51) Int. Cl. H04M 1/60; H04L 1/00; H04L 1/08

(52) U.S. Cl. CPC H04M 1/6066; H04L 1/0008; H04L 1/08

(57) ABSTRACT

In an embodiment, a method includes: initiating hands-free communication of a first wireless protocol between a first device and a second device in a wireless environment with the first device; when another wireless communication is active within the wireless environment, negotiating, with the second device, parameters of the hands-free communication, the parameters comprising at least one of repeated data communication in a plurality of communication intervals and a width of an inter-window gap that exceeds a width of a communication interval; and sending first data in a first communication interval of the plurality of communication intervals and, after the inter-window gap, sending at least second data in a second communication interval of the plurality of communication intervals.

### BACKGROUND

In certain situations, cell phone users want to communicate in a hands-free mode such as when driving a vehicle or otherwise on the go. To effect this operation, there is a short-range wireless communication (e.g., Bluetooth) between another device and the cell phone, and in turn the cell phone communicates with a cellular network.
A Hands-Free Profile (HFP) Bluetooth specification enables wireless communication between a mobile phone and a hands-free device, via a profile that defines a set of functions that allows the mobile phone to be used in conjunction with the hands-free device, such as a car kit or a headset. A Bluetooth link provides a wireless means for both remote control of the mobile phone by the hands-free device and voice connections between the devices. Compliance with this specification ensures interoperability between a Bluetooth-enabled hands-free device and any Bluetooth-equipped mobile phone supporting this profile.
In some wireless communication scenarios involving the co-existence of Bluetooth and other wireless protocols such as Wi-Fi in accordance with an IEEE 802.11 specification, interference can degrade the quality of voice transmissions in HFP applications. This interference leads to sub-optimal voice quality and a poor user experience, both with respect to a voice call as well as the additional wireless protocol.

### SUMMARY OF INVENTION

In one aspect, a method includes: initiating hands-free communication of a first wireless protocol between a first device and a second device in a wireless environment with the first device; when another wireless communication is active within the wireless environment, negotiating, with the second device, parameters of the hands-free communication, the parameters comprising at least one of repeated data communication in a plurality of communication intervals and a width of an inter-window gap that exceeds a width of a communication interval; and sending first data in a first communication interval of the plurality of communication intervals and, after the inter-window gap, sending at least second data in a second communication interval of the plurality of communication intervals.
In one implementation, the method further comprises sending information of the another wireless communication during the inter-window gap. The method may also include: sending, via a transceiver of the first device, the first data in the first communication interval of the plurality of communication intervals; and during the inter-window gap, sending, via the transceiver of the first device, the information of the another wireless communication.
In an implementation, the method further comprises sending the first data in the second communication interval. The method may also include: sending, in the first communication interval, a first packet comprising the first data; and sending, in the second communication interval, a second packet comprising the first data and the second data. Sending the second packet comprises sending the first data having a first width and the second data having the first width. The method may also include: buffering, in a memory of the first device, the first data; and after sending the second packet, flushing the first data from the memory.
In an implementation, the method further comprises: sending, in a reserved window of the first communication interval, a first packet comprising the first data; and in response to an indication from the second device that indicates that the second device did not successfully receive the first packet, sending, in a retransmission window of the first communication interval, the first packet comprising the first data.
When the another wireless communication is active within the wireless environment, negotiating, with the second device, the parameters of the hands-free communication including the repeated data communication in the plurality of communication intervals and the width of the inter-window gap that exceeds the width of the communication interval. When the another wireless communication is inactive within the wireless environment, negotiating, with the second device, the parameters of the hands-free communication including the width of the inter-window gap that is less than the width of the communication interval.
In another aspect, a wireless device includes: at least one transceiver to transmit and receive radio frequency (RF) signals; and a baseband processor coupled to the at least one transceiver to process baseband signals, where the baseband processor comprises a host for a first communication protocol and a controller for the first communication protocol, the host to provide first data to the controller. The controller is to: generate a first packet comprising the first data for the at least one transceiver to transmit in a first communication interval; and generate a second packet comprising the first data for the at least one transceiver to transmit in a second communication interval.
In an implementation, the at least one transceiver is to communicate information of another communication protocol during an inter-window gap between the first communication interval and the second communication interval. The wireless device, when the another communication protocol is active, is to negotiate, with a second wireless device, parameters of the first communication protocol, the parameters comprising at least one of repeated data communication in a plurality of communication intervals and a width of the inter-window gap that exceeds a width of a communication interval. The controller is to generate the first packet further comprising padding data. The controller is to generate the second packet further comprising second data, the first data and the second data having a common width. The controller is to buffer, in a memory of the wireless device, the first data for generation of the second packet.
In yet another aspect, a method includes: initiating hands-free communication of a first wireless protocol between the first wireless device and a second wireless device in a wireless environment with the first wireless device; when another wireless communication is active within the wireless environment, negotiating, with the second wireless device, parameters of the hands-free communication, the parameters comprising at least one of repeated data communication in a plurality of communication intervals and a width of an inter-window gap that exceeds a width of a communication interval; and sending first data in a first communication interval of the plurality of communication intervals and, after the inter-window gap, sending at least second data in a second communication interval of the plurality of communication intervals.
In an implementation, the method further comprises: sending, via a transceiver of the first wireless device, the first data in the first communication interval of the plurality of communication intervals; during the inter-window gap, sending, via the transceiver of the first wireless device, information of the another wireless communication; and sending, via the transceiver of the first wireless device, the first data and second data in the second communication interval of the plurality of communication intervals. The method may also include: buffering, in a memory of the first wireless device, the first data; and after sending the first data during the second communication window, flushing the first data from the memory.
In an implementation, the method further comprises: sending a first packet comprising the first data and padding data in a first packet during the first communication interval of the plurality of communication intervals; and after the inter-window gap, sending a second packet comprising the first data and second data during the second communication interval of the plurality of communication intervals.

### BRIEF DESCRIPTION OF THE DRAWINGS

FIG. 1 is a block diagram of a wireless environment in accordance with an embodiment.
FIG. 2 is a flow diagram of a method in accordance with an embodiment.
FIG. 3 is a timing diagram illustrating a wireless communication in accordance with an embodiment.
FIG. 4 is a timing diagram illustrating a wireless communication from a point of view of a transmitter in accordance with another embodiment.
FIG. 5 is a block diagram of a representative integrated circuit in accordance with an embodiment.

### DETAILED DESCRIPTION

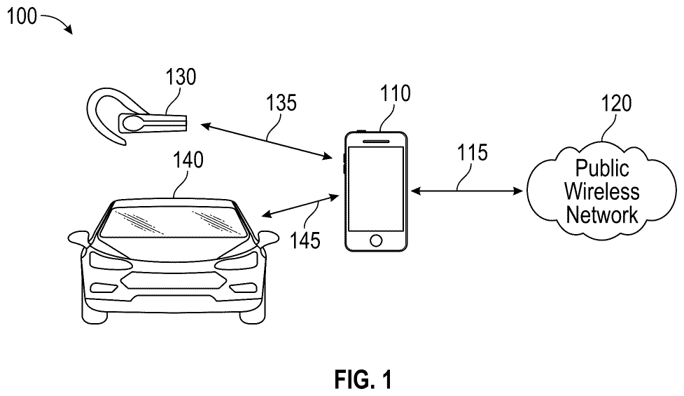

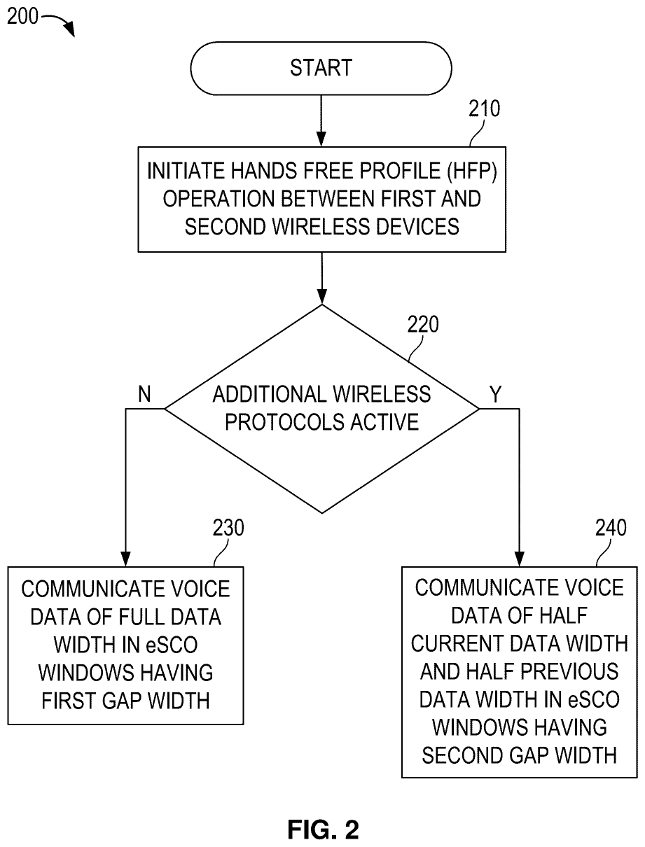

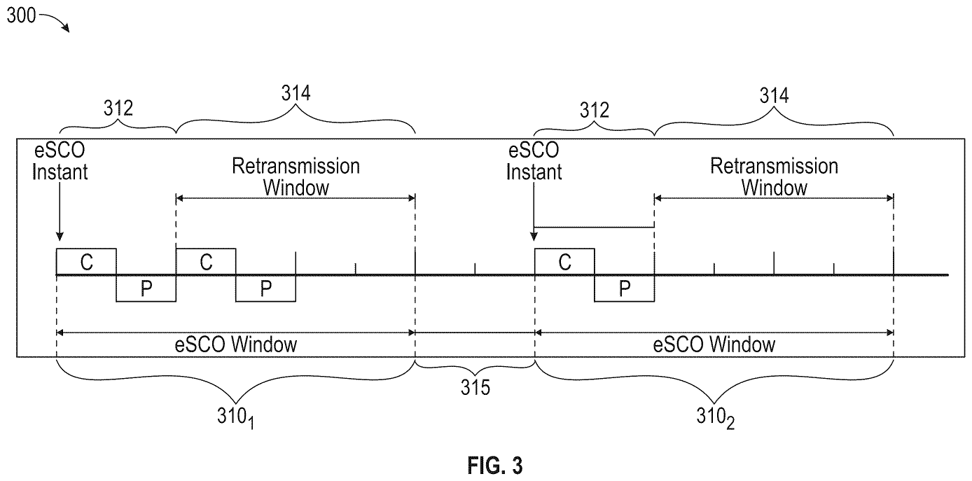

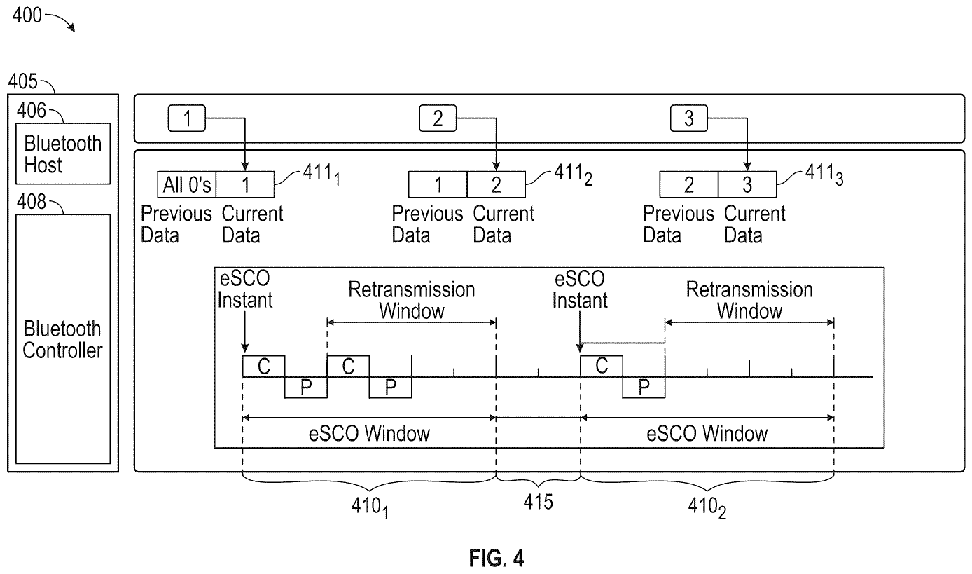

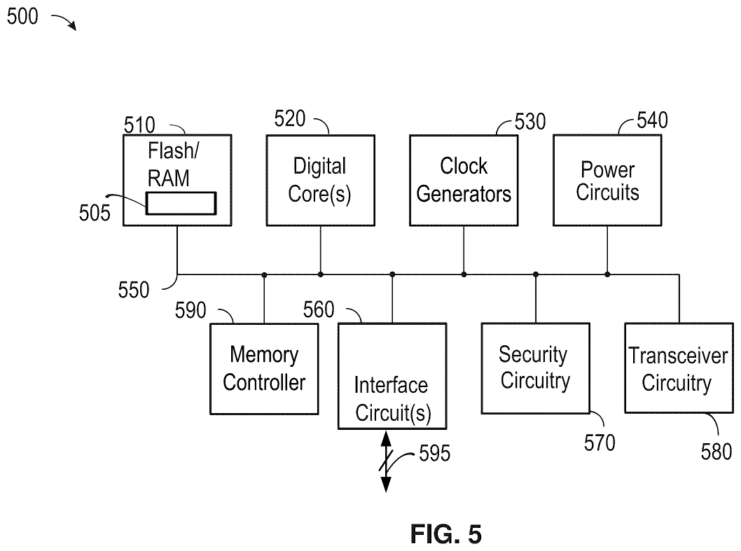

In various embodiments, wireless devices are configured to communicate in a hands-free mode, e.g., for cellphone calls or other voice data. During this hands-free mode of operation, the wireless devices can be configured to operate with intelligent scheduling of Bluetooth transmissions in a manner that allows communications of additional Bluetooth and/or other wireless protocols to occur between periodic windows established according to the intelligent scheduling.
With these capabilities, the devices may accurately communicate while co-existing with other wireless communications. Although embodiments are described herein in the context of a hands-free mode to enable cellular communications, understand that embodiments are not limited in this regard, nor are they limited to the Bluetooth extended synchronous (eSCO) data communications described herein. Furthermore, while illustrated implementations regard hands-free communication realized via a Bluetooth connection between a smartphone and another device, such as a headset, vehicle communication system or so forth, other devices may communicate voice or other synchronous data using the techniques described herein.
By intelligently scheduling voice communications in a HFP mode of operation over Bluetooth, voice quality may be improved within co-existence scenarios. This improved quality may be achieved by minimizing interference with other wireless protocols, which may use the same radio hardware in some cases.
According to HFP, a Bluetooth Classic connection is established between supported devices using an Asynchronous Connection-Less (ACL) logical link, where link layer protocol data units (PDUs) and asynchronous data are exchanged. In turn, a synchronous connection is established on top of the ACL logical link by exchanging a Link Management Protocol (LMP) Synchronous PDU.
Each synchronous logical link has an interval periodicity formed of a plurality of eSCO windows, where each such window in turn is formed of: a reserved window in which a voice data transmission (in the form of an eSCO packet) occurs; and a retransmission window in which transmission of the eSCO packet is retried should the packet sent during the reserved window not be successfully acknowledged.
Without an embodiment, these eSCO windows may have a nominal width of approximately 2.5 to 3.75 milliseconds (ms) and a nominal inter-window gap width of approximately 3.75 to 5 ms. Given this spacing between eSCO windows, there is limited time for allowing other wireless communications of a different wireless protocol to occur in a non-conflicting manner.
With an embodiment, eSCO windows can be intelligently scheduled to have a greater inter-window gap width, e.g., of at least approximately 11.25 to 12.5 ms, during which time wireless communications of another protocol can occur. Essentially, the intelligent scheduling provides extended gaps between eSCO windows to provide interference-free windows for communication via other wireless protocols. Although illustrative implementations may provide an intelligent scheduling in which every other eSCO window of a nominal eSCO scheduling is withheld, embodiments are not limited in this regard, and the intelligent scheduling described herein contemplates other inter-window gap spacing. Also in embodiments, data packets of the eSCO windows can include a mixture of current (new) and previously sent data, to ensure that the data is successfully received, as described further below.
Referring now to FIG. 1, shown is a block diagram of a wireless environment in accordance with an embodiment. More specifically, FIG. 1 illustrates possible devices that may communicate wirelessly using techniques for intelligent scheduling as described herein. In the context of FIG. 1, environment 100 includes a mobile phone 110. In embodiments, mobile phone 110 can be a smartphone having one or more wireless transceivers that can communicate according to multiple communication protocols, including at least a Wi-Fi protocol and one or more Bluetooth protocols, and also via a cellular protocol.
Thus as shown, mobile device 110 can make and receive voice calls via a public wireless network 120, to which it is coupled via a cellular connection 115. In addition, mobile phone 110 can communicate with devices in a local area via one or more other wireless protocols. For purposes of discussion, assume that mobile phone 110 communicates with a headset 130 and a hands-free unit 140 of a vehicle via at least corresponding Bluetooth connections 135, 145.
To enable hands-free communications, the various devices may implement a hands-free profile that is used to enable voice calls via headset 130 and/or hands-free unit 140, and through mobile phone 110 to wireless network 120. Such hands-free communications may occur using eSCO logical links as described herein. With this arrangement, a user can make hands-free calls via one or more of headset 130 and hands-free unit 140. And with embodiments, the user may make such calls via mobile phone 110, while co-existing with other wireless communications occurring within environment 100, such as according to Bluetooth and/or Wi-Fi protocols, as described herein. Although shown at this high level in the embodiment of FIG. 1, understand that mobile phone 110 may communicate wirelessly, e.g., via Bluetooth communications, with other devices to enable hands-free communication with the intelligent scheduling as described herein.
Referring now to FIG. 2, shown is a flow diagram of a method in accordance with an embodiment. As shown in FIG. 2, method 200 is a method for intelligent scheduling and communicating voice data using an HFP Bluetooth protocol. As such, method 200 can be performed by hardware circuitry of a wireless device such as a hands-free unit, cell phone or so forth, alone and/or in combination with firmware and/or software. For purposes of discussion, method 200 is described in the context of a hands-free unit to communicate using a HFP Bluetooth protocol with a mobile phone.
As illustrated, method 200 begins by initiating HFP operation between first and second wireless devices (block 210). This communication initiation may be pursuant to an initial negotiation between the devices to set initial parameters of the HFP communication. These devices can be a hands-free unit and a mobile phone. Next it is determined at diamond 220 whether additional wireless protocols are active. This determination may be based on whether the hands-free unit is also communicating wirelessly with other wireless devices, such as one or more Internet of Things (IoT) devices, e.g., sensors, actuators or so forth. Of course the additional wireless protocols also may be associated with other wireless communications between the first and second wireless devices and/or with other wireless devices, such as smartwatches or other body sensors or so forth.
Based at least in part on this determination of wireless activity, potentially an additional negotiation is performed, which may occur to set wider inter-window gaps and/or repeated data communications as described herein. In addition to these parameters negotiated between the devices, there may be further operations within a device to set these device parameters. As an example, a codec layer can be informed using an HFP AT frames codec selection, where a vendor codec can be used to imitate the other device, and also to provide codec data having previous and present eSCO anchor points.
If it is determined that no additional wireless protocols are active, control passes to block 230, where voice data may be communicated of full data width in eSCO windows having a first gap width. Here, the full data width may be according to a nominal data width for a configured eSCO packet type (e.g., 60-90 bytes). And the first gap width may be a nominal inter-window gap width of 5 ms. As discussed above, prior to the beginning of this voice communication, the devices may enter into a negotiation in which these parameters for the eSCO windows and inter-window gaps can be determined.
Still referring to FIG. 2, instead if it is determined that an additional wireless protocol such as a Wi-Fi protocol or another Bluetooth communication is active, control passes to block 240. At block 240, voice data may be communicated having half current data and half previous data within a given eSCO window. In an embodiment, packet duration can be increased as the data of each of the current and previous packets can be of typical data width. As an example, assume a slot width of 625 microseconds (usec) and a regular packet uses 240 usec, a packet having current and previous data can have an increased packet width of 480 usec, while maintaining the same slot width.
And the inter-window gap may of a second gap width, which may be approximately twice the first gap width. In this way, a larger inactive period may occur between eSCO windows during which the other wireless communications may occur without interference by the HFP Bluetooth communications. For example, inter-window gap 315 may have a duration that is 2 to 3 times more than a conventional gap. Although shown at this high level in the embodiment of FIG. 2, understand that many variations and alternatives are possible.
Referring now to FIG. 3, shown is a timing diagram illustrating a wireless communication in accordance with an embodiment. As shown in FIG. 3, in timing diagram 300 there are a plurality of communication intervals 310_{1, 2}. Each communication interval 310 includes a reserved window 312 and a retransmission window 314. While in the embodiment shown, reserved windows 312 have a smaller width than retransmission windows 314, embodiments are not limited in this aspect. As further illustrated, a null period 315 is present between each communication interval. Although not drawn to scale, in embodiments null period 315, also referred to herein as an inter-window gap, may have a width that is at least twice the width of communication interval 310, and 2 to 3 times greater than a conventional null period.
In FIG. 3, during a first portion of a reserved slot 312, a forward transmission is sent (denoted with a ‘C’ indicating a transmission from central device). This transmission is sent at a negotiated primary rate to transmit the packet (which may be formed of one or more slots). Although not shown for ease of illustration understand that the data of this packet may include both current data and previous data, namely a first portion including data transmitted for a first time and a second portion including data previously transmitted. After the forward transmission, but still within reserved window 312, the receiving device sends an acknowledgement back (denoted with a ‘P’ indicating a transmission from peripheral device). When successfully received, the receiving device sends a positive acknowledgement to indicate successful receipt, and instead, when not correctly received, it sends a negative acknowledgment (e.g., a NAK).
In the instance where the receiving device does not successfully receive the transmitted packet, the transmitter sends a retransmission of the packet during retransmission window 314, as shown in FIG. 3. In turn, the receiving device sends an acknowledgment to indicate whether it successfully receives the packet. Thus during communication interval 310₁, packet data is sent at least once, and twice if it is not correctly received the first time.
As further illustrated in FIG. 3, note that during second communication interval 310₂, a successful receipt of the packet sent during reserved window 312 is acknowledged, and thus there is no transmission that occurs during retransmission window 314 of second communication interval 310₂. Of course, different window sizes and transmission patterns may occur in other embodiments.
Referring now to FIG. 4, shown is a timing diagram illustrating a wireless communication from a point of view of a transmitter in accordance with another embodiment. As shown in FIG. 4, in timing diagram 400 there are a plurality of communication intervals 410_{1, 2} with an inter-window gap 415 therebetween. As discussed above, in embodiments the width of inter-window gap 415 may be between approximately 11.25 to 12.5 ms, and thus multiple widths of a given communication interval 410. Although not shown in the detail of FIG. 4, each communication interval 410 includes a reserved window and a retransmission window, as discussed above.
In FIG. 4, a transmitter 405 is shown at a high level, including a host processor 406, e.g., a Bluetooth host, and a controller 408, e.g., Bluetooth controller. In an embodiment, transmitter 405 may include a baseband processor having host 406 and controller 408. In other embodiments, there can be different processors such as a host processor that implements a Bluetooth host and a baseband processor that implements a Bluetooth controller. And shown, during each communication interval 410, Bluetooth host 406 provides new data to Bluetooth controller 408 (denoted as 1, 2, and 3). This new data, which has not previously been transmitted, is also referred to herein as current data. In turn, Bluetooth controller 408 forms a packet for transmission that includes this new data, along with previous data. Note for first communication interval 410₁, as there is no previous data, Bluetooth controller 408 may include padding data (e.g., all zeros) for the portion of the packet corresponding to the previous data.
Thus as shown, in first communication interval 410₁, packet 411₁ is sent formed of a first portion having all zeros and a second portion having the current data. As discussed above, during communication interval 410₁, packet 411₁ is sent during a reserved window, and if it is not successfully received, it is resent during a retransmission window.
Referring to FIG. 4, in following communication intervals, current data is concatenated with previous data and is accordingly sent as data packets 411_{2,3}. Note that Bluetooth controller 408 also stores and then flushes, from a buffer or other temporary storage, the previous data at a conclusion of each communication interval 410.
With an embodiment as shown in FIG. 4, it can be safely assumed that all data is successfully received, as each portion of a packet (the previous and current data) may be sent up to a maximum of four times, owing to its potential communication in reserved and retransmission windows of two consecutive communication intervals. Although shown at this high level in the embodiment of FIG. 4, many variations and alternatives are possible.
Embodiments can be implemented in a variety of wireless device use cases. Referring now to FIG. 5, shown is a block diagram of a representative integrated circuit 500 that includes transceiver circuitry, as described herein. In the embodiment shown in FIG. 5, integrated circuit 500 may be, e.g., a multi-mode wireless transceiver that may operate according to one or more wireless protocols (e.g., Wi-Fi and Bluetooth, among others) or other device that can be used in a variety of use cases. In one or more embodiments, the circuitry of integrated circuit 500 shown in FIG. 5 may be implemented on a single semiconductor die or implemented on separate dies for wireless communication.
Integrated circuit 500 may be included in a range of devices, but for purposes of discussion, it may be incorporated into a headset, vehicle infotainment system or other system such as shown in FIG. 1. In the embodiment shown, integrated circuit 500 includes a memory system 510 which in an embodiment may include volatile storage, such as RAM and non-volatile memory such as a flash memory. The flash memory is a non-transitory storage medium that can store instructions and data. In embodiments, this storage may store a link manager 505₁ that can enable and configure the device for eSCO communication having larger inter-window gaps and packets formed of concatenated new and previous data, as described herein. In this way, HFP Bluetooth communications can better co-exist with other wireless communications, which may occur within such inter-window gaps. As further shown integrated circuit 500 also may include a memory controller 590.
Memory system 510 couples via a bus 550 to one or more digital cores 520, which may include one or more cores and/or microcontrollers that act as processing units of the integrated circuit, and which may execute link manager operations. In turn, digital cores 520 may couple to clock generators 530 which may provide one or more phase locked loops or other clock generator circuitry to generate various clocks for use by circuitry of the IC.
As further illustrated, IC 500 further includes power circuitry 540. Additional circuitry may be present depending on particular implementation to provide various functionality and interaction with external devices. Such circuitry may include interface circuitry 560 which provides a digital communication interface with additional circuitry. IC 500 also may include security circuitry 570 to perform wireless security techniques.
In addition, as shown in FIG. 5, transceiver circuitry 580 may be provided to enable transmission and reception of wireless signals, e.g., according to one or more of a local area or wide area wireless communication scheme, such as Zigbee, Bluetooth, IEEE 802.11, IEEE 802.15.4, cellular communication or so forth. Transceiver circuitry 580 may communicate synchronous data in packets having current and previous data as described herein. Understand while shown with this high level view, many variations and alternatives are possible.
While the present disclosure has been described with respect to a limited number of implementations, those skilled in the art, having the benefit of this disclosure, will appreciate numerous modifications and variations therefrom. It is intended that the appended claims cover all such modifications and variations.

What is claimed Is:

1. A method comprising:
initiating hands-free communication of a first wireless protocol between a first device and a second device in a wireless environment with the first device;
when another wireless communication is active within the wireless environment, negotiating, with the second device, parameters of the hands-free communication, the parameters comprising at least one of repeated data communication in a plurality of communication intervals and a width of an inter-window gap that exceeds a width of a communication interval; and
sending first data in a first communication interval of the plurality of communication intervals and, after the inter-window gap, sending at least second data in a second communication interval of the plurality of communication intervals.

2. The method of claim 1, further comprising sending information of the another wireless communication during the inter-window gap.

3. The method of claim 2, further comprising:
sending, via a transceiver of the first device, the first data in the first communication interval of the plurality of communication intervals; and
during the inter-window gap, sending, via the transceiver of the first device, the information of the another wireless communication.

4. The method of claim 1, further comprising sending the first data in the second communication interval.

5. The method of claim 1, further comprising:
sending, in the first communication interval, a first packet comprising the first data; and
sending, in the second communication interval, a second packet comprising the first data and the second data.

6. The method of claim 5, wherein sending the second packet comprises sending the first data having a first width and the second data having the first width.

7. The method of claim 5, further comprising:
buffering, in a memory of the first device, the first data; and
after sending the second packet, flushing the first data from the memory.

8. The method of claim 1, further comprising:
sending, in a reserved window of the first communication interval, a first packet comprising the first data; and
in response to an indication from the second device that indicates that the second device did not successfully receive the first packet, sending, in a retransmission window of the first communication interval, the first packet comprising the first data.

9. The method of claim 1, when the another wireless communication is active within the wireless environment, negotiating, with the second device, the parameters of the hands-free communication, the parameters comprising the repeated data communication in the plurality of communication intervals and the width of the inter-window gap that exceeds the width of the communication interval.

10. The method of claim 1, further comprising, when the another wireless communication is inactive within the wireless environment, negotiating, with the second device, the parameters of the hands-free communication, the parameters comprising the width of the inter-window gap that is less than the width of the communication interval.

11. A wireless device comprising:
at least one transceiver to transmit and receive radio frequency (RF) signals; and
a baseband processor coupled to the at least one transceiver to process baseband signals, wherein the baseband processor comprises a host for a first communication protocol and a controller for the first communication protocol, wherein the host is to provide first data to the controller, and the controller is to:
generate a first packet comprising the first data for the at least one transceiver to transmit in a first communication interval; and
generate a second packet comprising the first data for the at least one transceiver to transmit in a second communication interval.

12. The wireless device of claim 11, wherein the at least one transceiver is to communicate information of another communication protocol during an inter-window gap between the first communication interval and the second communication interval.

13. The wireless device of claim 12, wherein the wireless device, when the another communication protocol is active, is to negotiate, with a second wireless device, parameters of the first communication protocol, the parameters comprising at least one of repeated data communication in a plurality of communication intervals and a width of the inter-window gap that exceeds a width of a communication interval.

14. The wireless device of claim 11, the controller is to generate the first packet further comprising padding data.

15. The wireless device of claim 11, wherein the controller is to generate the second packet further comprising second data, the first data and the second data having a common width.

16. The wireless device of claim 15, wherein the controller is to buffer, in a memory of the wireless device, the first data for generation of the second packet.

17. A non-transitory storage medium comprising instructions that when executed cause a first wireless device to perform a method comprising:
initiating hands-free communication of a first wireless protocol between the first wireless device and a second wireless device in a wireless environment with the first wireless device;
when another wireless communication is active within the wireless environment, negotiating, with the second wireless device, parameters of the hands-free communication, the parameters comprising at least one of repeated data communication in a plurality of communication intervals and a width of an inter-window gap that exceeds a width of a communication interval; and
sending first data in a first communication interval of the plurality of communication intervals and, after the inter-window gap, sending at least second data in a second communication interval of the plurality of communication intervals.

18. The non-transitory storage medium of claim 17, wherein the method further comprises:
sending, via a transceiver of the first wireless device, the first data in the first communication interval of the plurality of communication intervals;
during the inter-window gap, sending, via the transceiver of the first wireless device, information of the another wireless communication; and
sending, via the transceiver of the first wireless device, the first data and second data in the second communication interval of the plurality of communication intervals.

19. The non-transitory storage medium of claim 18, wherein the method further comprises:
buffering, in a memory of the first wireless device, the first data; and
after sending the first data during the second communication window, flushing the first data from the memory.

20. The non-transitory storage medium of claim 17, wherein the method further comprises:
sending a first packet comprising the first data and padding data in a first packet during the first communication interval of the plurality of communication intervals; and
after the inter-window gap, sending a second packet comprising the first data and second data during the second communication interval of the plurality of communication intervals.
